(19) United States
(12) Patent Application Publication
(10) Pub. No.: US 2024/0335894 A1
(43) Pub. Date: Oct. 10, 2024

(54) METHOD OF MONITORING THE CONDITION OF A GEAR CUTTING MACHINE

(71) Applicant: Reishauer AG, Wallisellen (CH)

(72) Inventor: Christian DIETZ, Wallisellen (CH)

(73) Assignee: Reishauer AG, Wallisellen (CH)

(21) Appl. No.: 18/700,021

(22) PCT Filed: Oct. 6, 2022
(86) PCT No.: PCT/EP2022/077838

§ 371 Date: Apr. 10, 2024

(30) Foreign Application Priority Data
Oct. 11, 2021 (CH) 070374/2021

(51) Int. Cl. B23F 23/12; B23Q 17/00; B23Q 17/09; B23Q 17/12; B23Q 17/20

(52) U.S. Cl. CPC B23F 23/12; B23Q 17/007; B23Q 17/098; B23Q 17/12; B23Q 17/20

(57) ABSTRACT

In a method of monitoring a condition of a machine tool (1) having a plurality of machine axes, at least a part of the machine axes is systematically actuated in a test cycle, and associated condition data are obtained by measurements. On this basis, EOL data correlating with a noise behavior of a gear train comprising a workpiece machined by the gear cutting machine are predicted. Disclosed is also the reverse direction in which condition data are predicted from EOL data.

### TECHNICAL FIELD

The present invention relates to a method of monitoring the condition of a gear cutting machine for machining toothed workpieces, in particular a gear grinding machine.

### PRIOR ART

During the hard finishing of toothed workpieces, in particular external or internal gears, in a gear cutting machine, manufacturing deviations naturally occur, which manifest themselves in deviations of the actually manufactured actual geometry of the workpieces from a specified nominal geometry. The manufacturing deviations can be caused, among other things, by malfunctions or wear of the various components of the gear cutting machine or by unsuitable assembly of the components. For example, a manufacturing deviation can be caused by a drive moving a slide of the gear cutting machine to a position other than the nominal position specified by the machine controller, by a worn bearing of a spindle, or by machine parts being connected to each other in an unsuitable manner so that vibrations are not sufficiently damped.

Hard finishing is usually the last step in workpiece machining. After this machining step, the workpieces are assembled into gear trains. After assembly, a final test (“EOL test”) of the gear trains is carried out on an EOL test bench (EOL=End of Line). In particular, the noise behavior of the gear train is tested. Manufacturing deviations of the workpieces often lead to undesired noise excitations. Even the smallest manufacturing deviations, as can occur during machining on a faultless machine, can lead to noise. Particularly in the case of electric drives, the gear train components are sometimes the dominant noise source, and noise development in the gear train is particularly disturbing.

It is desirable to be able to predict the noise behavior caused by a workpiece before the workpiece is installed in a gear train in order to avoid expensive disassembly, which becomes necessary if the gear train is found to be susceptible to noise during EOL testing. It is also desirable to be able to draw direct conclusions about specific causes in the gear cutting machine from the measured noise behavior of a gear train.

U.S. Pat. No. 20,140,256223A1 discloses a method of hard finishing of tooth flanks with corrections and/or modifications on a gear cutting machine, wherein gear pairs which are in engagement with each other within a transmission or a test device are machined taking into account the respective mating flanks, and wherein the tooth flanks of the relevant workpieces are provided with periodic waviness corrections or modifications. By means of rotational distance error measurement of the gear pairs in a gear measuring device and/or in a transmission, the rotational error extent is determined. This measurement result serves as an input value for defining the amplitude, frequency and phase position for the periodic flank waviness corrections on the tooth flanks of the gear pairs for production in the gear cutting machine.

### SUMMARY OF THE INVENTION

### First Aspect: Prediction of Noise Excitations

In a first aspect, it is an object of the present invention to provide a method of monitoring the condition of a gear cutting machine to predict, at an early stage, the development of disturbing noises in a gear train comprising a workpiece machined with the gear cutting machine.

This object is solved by a method according to claim 1. Further embodiments are given in the dependent claims.

Thus, a method of monitoring a condition of a gear cutting machine having a plurality of machine axes is disclosed, comprising the following steps:
a) performing a test cycle, wherein in the test cycle at least a portion of the machine axes is systematically actuated and associated machine measurement data are obtained;
b) performing spectral analysis of the machine measurement data, wherein machine spectral data are calculated from the machine measurement data; and
c) determining predicted EOL spectral data based on the machine spectral data, wherein the predicted EOL spectral data indicates at which orders excitations are to be expected in an EOL spectrum when a workpiece machined with the gear cutting machine is installed in a gear train and rolls off on a mating gear in the gear train.

The method may comprise:
d) outputting the predicted EOL spectral data or at least one quantity derived therefrom.

In the context of the proposed method, machine measurement data are thus determined in a test cycle while machine axes are selectively actuated. The test cycle takes place during a machining pause of the gear cutting machine, i.e. during the test cycle the machining tool of the gear cutting machine is not in machining engagement with a workpiece. The machine measurement data may be, in particular, acceleration values determined with an acceleration sensor, position values determined with a position sensor, and/or current values determined with a current sensor. Machine spectral data (spectral condition data for the machine) are calculated from the machine measurement data by means of a spectral analysis (in particular an order analysis) in order to determine at which frequencies or orders periodic excitations of machine components occur while a machine axis is actuated.

Based on the machine spectral data, EOL spectral data are predicted. This prediction is based on the following considerations: The excitations of the machine components are propagated to the manufactured workpieces during machining. When the machining tool is dressed using the machine axes, these excitations are also propagated to the tool so dressed, from where they are further propagated to the workpiece during machining. Using the known kinematic linkage between the individual machine components and taking into account the selected machining parameters, it is possible to calculate how such excitations affect the manufactured workpieces. In particular, such excitations can lead to periodic deviations (waviness) on the tooth flanks of the workpieces. The expression “kinematic linkage” or “kinematic chain” is used to describe the way in which a movement of one component is propagated to another component in the machining process. In the machining process, the kinematic linkage between the tool spindle and the workpiece spindle plays a central role, i.e. the way in which movements of the tool correlate with movements of the workpiece. If the gear cutting machine is a machine for machining of the workpiece with a generating process, such as a generating grinding machine or a gear skiving machine, this linkage is characterized by the rolling engagement between the workpiece and the tool and is determined by the workpiece geometry and the tool geometry. The way in which a periodic excitation of the tool is propagated to the workpiece flanks as a waviness by this linkage can be readily calculated. In particular, it is readily possible to calculate the order, with respect to workpiece rotation, that an excitation generated by the waviness will have in the gear train, if the order, with respect to tool rotation, of the excitation of the tool that is causative for it is known. The ratio between these two orders will be referred to as the “propagation factor” in the following. For all other components between which motions are propagated, it is also possible to calculate how vibrations of one of these components affect the other component, and in particular to calculate the corresponding propagation factors between perturbation orders of these components and the resulting perturbation orders in the EOL spectrum.

Thus, calculating the predicted EOL spectral data may involve applying a propagation factor to the machine spectral data, where the propagation factor depends on the kinematic linkage between the machine axis for which the machine spectral data was determined and the workpiece.

Thus, predicted EOL spectral data are obtained by the specified method. These predicted EOL spectral data are based on a test of the real machine condition and thus include sources of perturbation in the machine which may not have been known a priori and therefore cannot be included in a calculation or simulation of EOL spectral data based purely on the known design of the machine. As a result, the method allows a reliable prediction of at which orders noise excitations will occur in the finished gear train. In this way, noise excitations can be predicted even before the workpieces are actually installed in gear trains. The affected workpieces can be rejected and, if necessary, inspected in more detail, and the time-consuming dismantling of fully assembled gear trains can thus be avoided. In addition, measures can be taken to identify and eliminate the source of the error that leads to the expected noise developments.

It is important to note that the determination of the predicted EOL spectral data are not necessarily a quantitative prediction of the noise intensities at the various orders, but rather a qualitative indication of which orders are “perturbation orders” in the first place, i.e., which orders are expected to have significant noise intensity at all. In particular, the predicted EOL spectral data may include the perturbation orders and associated intensity indicators, with the intensity indicators representing (possibly only very rough) estimates of expected perturbation intensities at the perturbation orders.

In particular, the predicted EOL spectral data may be determined individually per actuated machine axis, i.e. separate machine measurement data are determined for each machine axis that is activated during a test cycle, separate machine spectral data are calculated from this separate machine measurement data, and based on this, separate EOL spectral data are predicted per actuated machine axis. In this way, it becomes possible to predict which machine axis can cause which perturbation orders in the EOL spectral data.

Preferably, steps a) to c) are repeated several times, with workpieces being machined with the gear cutting machine between the test cycles and the test cycles being performed during machining pauses in which the machining tool is not in a machining engagement with a workpiece. A development of the predicted EOL spectral data as a function of the test cycle or time is then visualized and/or analyzed. This is based on the consideration that predicted EOL spectral data may sometimes be of little value based on a single test cycle. However, during machining, wear or failure of gear cutting machine components can occur, which then manifest themselves in a significant change in the predicted EOL spectral data. Therefore, it is proposed to consider the temporal evolution of the predicted EOL spectral data. By appropriately visualizing the temporal change in the predicted EOL spectral data, perturbation orders that are expected to experience significant changes in noise excitation behavior with time can be easily identified visually. The evolution of the calculated EOL spectral data may also be analyzed numerically. For example, a numerical analysis may include performing a regression analysis of the expected perturbation intensities for selected or all orders of perturbation using appropriate regression functions, such as a polynomial of at least second order. For example, a warning indicator may be determined and output on this basis if the analysis shows that at least one perturbation order is expected to have a gradient in perturbation intensity that satisfies a certain warning criterion.

If reference machine spectral data are available for many reference machines determined in many different reference test cycles, reference EOL spectral data may be predicted from each of these reference machine spectral data. It is then possible to automatically evaluate the predicted EOL spectral data of the machine to be evaluated by comparing them with the predicted reference EOL spectral data of the reference machines or quantities derived from them, and thus to automatically infer expected noise problems without requiring any special knowledge and without requiring measured EOL spectra as a basis for evaluation. In particular, a statistical analysis of the predicted reference EOL spectral data may be performed for this purpose. With respect to the considerations underlying this approach and further embodiments, reference is made to the patent application filed on the same date as the present application by the same applicant entitled “Method of monitoring the condition of a machine tool”, the contents of which are incorporated by reference in their entirety in the present disclosure.

### Second Aspect: Identification of Components Causing Noise Problems

The reverse is also possible, namely measuring EOL measured values on the EOL test bench while the workpiece is rolling off on a mating gear in the gear train, performing a spectral analysis of the EOL measured values to determine measured EOL spectral data, and concluding from the EOL spectral data what individual components of the gear cutting machine condition cause perturbation orders in the EOL spectral data due to their condition. The EOL measured values may be determined by any suitable sensors of the EOL test bench, in particular acceleration sensors and sensors for determining rotation errors.

Thus, a method of monitoring a condition of a gear cutting machine having a plurality of machine axes is disclosed, comprising the following steps:
a) performing an EOL test on a gear train comprising a workpiece machined by the gear cutting machine, wherein in the EOL test the workpiece in the gear train rolls off on a mating gear and associated EOL measurement data are determined;
b) performing a spectral analysis of the EOL measurement data, wherein EOL spectral data are calculated from the EOL measurement data; and
c) determining predicted condition data based on the EOL spectral data, wherein the predicted condition data for at least one machine axis indicates which orders of that machine axis are consistent with the calculated EOL spectral data.

The method may comprise:
d) outputting the predicted condition data or at least one quantity derived therefrom.

With this method, conclusions can be drawn as to which machine axes and, if applicable, which components of these machine axes are responsible for perturbation noises that actually occurred after a workpiece machined with the gear cutting machine was installed in a gear train. This method also takes advantage of the fact that the orders of perturbation noises, related to the rotation of the workpiece in the gear train, can be easily calculated from the orders of measurement data determined for the components of the gear cutting machine if the kinematic linkages between the components of the gear cutting machine are known and the selected machining parameters are taken into account.

In particular, this method may be carried out without the need for condition measurements on the gear cutting machine itself. However, particular advantages arise when this method is combined with condition measurements on the gear cutting machine. In this respect, the method may additionally comprise:
e) performing a test cycle in which at least a portion of the machine axes are systematically actuated and associated machine measurement data are obtained;
f) performing a spectral analysis in which machine spectral data are calculated from the machine measurement data; and
g) determining predicted EOL spectral data based on the machine spectral data, wherein the predicted EOL spectral data indicates at which orders excitations are to be expected in an EOL spectrum when a workpiece machined by the gear cutting machine is installed in a gear train and rolls off on a mating gear in the gear train, wherein determining the predicted condition data comprises comparing the EOL spectral data calculated from the EOL measurement data to the predicted EOL spectral data.

By comparing EOL spectral data determined by measurements during a test run of the gear train with EOL spectral data predicted from measurement data of the gear cutting machine, causes of perturbation noise can be determined particularly reliably.

### Third Aspect: Use of a Machine Learning Algorithm

The methods discussed so far require knowledge of kinematic linkages between components of the gear cutting machine. In another aspect, the invention provides a method that makes it possible to predict the noise behavior of a gear train based on measurements of the machine condition, or to draw conclusions about the condition of the gear cutting machine from the measured noise behavior of a gear train, even without knowledge of the kinematic linkages. This method uses a trained machine learning algorithm whose input variables are condition data of the gear cutting machine and whose output variables are predicted EOL data that are characteristic of the expected noise behavior of the gear cutting machine, or whose input variables are EOL data and whose output variables are predicted condition data that are characteristic of an expected condition of the machine.

The machine learning algorithm is trained using the following procedure:
a) performing a test cycle in which at least a portion of the machine axes is systematically actuated and associated condition data are determined by measurements;
b) machining at least one workpiece with the gear cutting machine while the gear cutting machine is in a condition that corresponds to the condition data;
c) installing the machined workpiece in a gear train;
d) performing an EOL test on the gear train, wherein in the EOL test the workpiece in the gear train rolls off on a mating gear and associated EOL data are determined;
e) storing the condition data and the corresponding EOL data in a training data set;
f) repeating steps a) through e) for a plurality of test cycles and machined workpieces, wherein the workpieces have the same nominal geometry and are machined under the same machining conditions; and
g) training the machine learning algorithm with the training data set.

The training data set thus contains a large number of condition data together with the corresponding EOL data for a plurality of workpieces that have the same nominal geometry, were machined under the same machining conditions and were installed in the same type of gear train.

The nominal geometry includes in particular quantities such as normal module, number of teeth and helix angle of the gear's toothing, but may also include further quantities such as specified tooth flank modifications. Machining conditions are considered to be the same in particular if the machine axes are moved in the same way during the machining operations. For example, if generating grinding is used as the machining process, the machining conditions are the same if the workpieces are machined with the same radial infeed, the same axial feed rate and the same shift speed, if the tool rotational speed is the same for all workpieces, and if the grinding worm used has the same number of starts and the same pitch height for all workpieces, so that the resulting rotational speed of the workpiece is also the same. If the grinding worm is a dressable grinding worm that is dressed with a rotating disk-shaped dressing tool, the conditions during dressing are also part of the machining parameters, in particular the rotational speed of the tool spindle and the rotational speed of the dressing tool during the dressing process.

The machine learning algorithm is trained with the condition data and the corresponding EOL data. As a result, the machine learning algorithm can make a prediction of EOL data based on condition data or vice versa without the need for knowledge of the kinematic linkages between the components of the gear cutting machine.

There are many different types of machine learning algorithms known that may be used in this context, and the structure of the training data set may vary accordingly. In particular, classification algorithms are suitable for practical implementation. For this purpose, the output variables can be reduced to a limited number of classes. For example, if the input variables are EOL data and the output variables are predicted condition data, the predicted condition data may consist of, for example, one real value per machine axis. Each value may then indicate, for example, a probability that the machine axis in question is responsible for the observed EOL data. The training data should then contain condition data representing a single real condition value per machine axis and associated EOL data. For example, if the input variables are condition data and the output variables are predicted EOL data, the predicted EOL data may consist of one real value per order for a relatively small number of orders (the orders that are particularly important in practice). Each value may then indicate, for example, a predicted relative spectral intensity of the order in question. The training data should then contain corresponding EOL data. Of course, completely different, even more complex output quantities are also conceivable. For practical implementation, an artificial neural network (ANN) or a support vector machine (SVM) is suitable, for example. In a particularly simple example, the input variables may be condition data, and the output variable is a single real value that characterizes the global noise behavior of the entire gear train on the EOL test bench. For example, a random forest is suitable as a machine learning algorithm for predicting such a value. With such a value, for example, an expected problematic noise behavior can be easily detected and measures can be taken to prevent affected workpieces from being installed in gear trains.

The condition data may generally comprise data of various kinds that correlate with the condition of a machine axis with respect to its vibration behavior. In particular, the condition data may comprise machine spectral data as defined in the context of the first and second aspects.

The EOL data may also comprise data of various types that correlate with the noise performance of the gear train. In particular, the EOL data may comprise EOL spectral data as defined in the context of the first and second aspects.

The training data may be stored in a database. The database may be located remotely from the machine being monitored. It may also be implemented in the cloud, e.g., in the form of computer resources shared by multiple users as a service. An evaluation computer may access the database for training the machine learning algorithm. The evaluation computer is also preferably spatially separated from the machine tool. It is connected to the machine tool by a network connection. The evaluation computer also need not be a single physical unit, but may be implemented in the cloud.

The invention further provides a device for monitoring a condition of a gear cutting machine having a plurality of machine axes, comprising a processor and a storage medium on which a computer program is stored. The computer program, when executed on the processor, causes at least a portion of the method steps of one of the methods explained above to be executed. The invention further provides a corresponding computer program. The computer program may be stored on a non-volatile storage medium.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic view of a generating grinding machine;

FIG. 2 shows a diagram explaining spectral data obtained in measurement cycles;

FIG. 3 shows a sketch with EOL test bench;

FIGS. 4A

and 4B show extracts from a table for converting orders of machine components to orders of a workpiece installed in a gear train on an EOL test bench;

FIG. 5 shows a diagram explaining spectral prediction data;

FIG. 6 shows a schematic representation of a time evolution of the perturbation intensity at a perturbation order;

FIG. 7 shows a sketch illustrating a machine learning algorithm; and

FIG. 8 shows an excerpt of exemplary training data for the machine learning algorithm.

### DESCRIPTION OF PREFERRED EMBODIMENTS

### Exemplary Structure of a Generating Grinding Machine

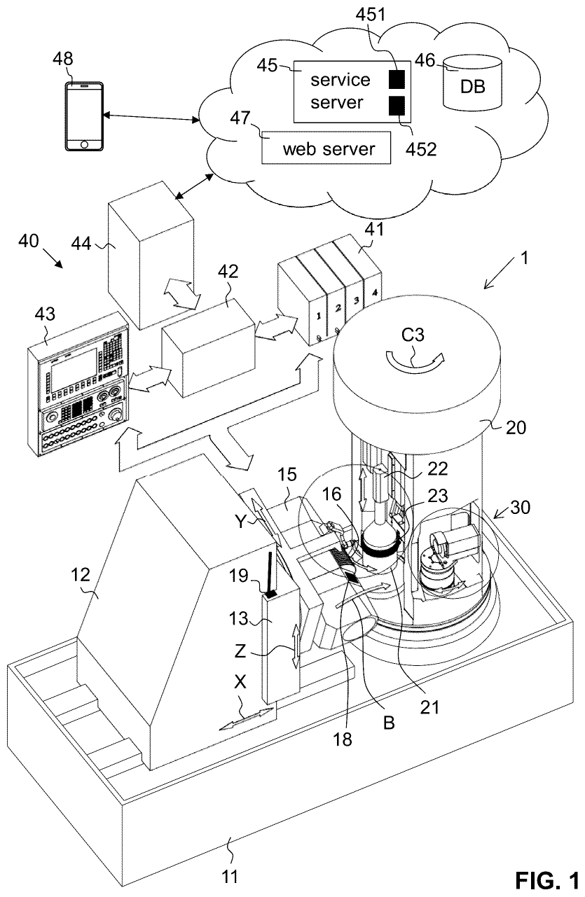

FIG. 1 shows a generating grinding machine 1 as an example of a gear cutting machine, which will also be abbreviated to “machine” in the following. The machine 1 has a machine bed 11 on which a tool carrier 12 is displaceably guided along a radial infeed direction X. The tool carrier 12 carries an axial slide 13, which is guided displaceably along an axial feed direction Z relative to the tool carrier 12. A grinding head 14 is mounted on the axial slide 13, which can be swiveled about a swivel axis running parallel to the X direction (the so-called A axis) to adapt to the helix angle of the gearing to be machined. The grinding head 14 in turn carries a shift slide on which a tool spindle 15 can be shifted along a shift direction Y relative to the grinding head 14. A worm-shaped profiled grinding wheel (grinding worm) 16 is clamped on the tool spindle 15. The grinding worm 16 is driven by the tool spindle 15 to rotate around a tool axis B.

The machine bed 11 also supports a swiveling workpiece carrier 20 in the form of a turret that can be swiveled between at least three positions about a swivel axis C3. Two identical workpiece spindles are mounted diametrically opposite each other on the workpiece carrier 20, of which only one workpiece spindle 21 with associated tailstock 22 is visible in FIG. 1. A workpiece can be clamped on each of the workpiece spindles and driven to rotate about a workpiece axis C1 or C2. The workpiece spindle 21 visible in FIG. 1 is in a machining position in which a workpiece 23 clamped on it can be machined with the grinding worm 16. The other workpiece spindle, which is offset by 180° and is not visible in FIG. 1, is in a workpiece change position in which a finished workpiece can be removed from this spindle and a new blank can be clamped onto it. A dressing device 30 is mounted offset by 90° to the workpiece spindles.

Machine 1 thus has a large number of movable components such as slides or spindles, which can be moved under the control of corresponding drives. These drives are often referred to in the technical world as “NC axes”, “machine axes” or abbreviated as “axes”. In some cases, this designation also includes the components driven by the drives, such as slides or spindles.

The machine 1 also has a large number of sensors. As an example, only two sensors 18 and 19 are shown schematically in FIG. 1. Sensor 18 is an acceleration sensor (vibration sensor) for detecting vibrations of the housing of grinding spindle 15. Sensor 19 is a position sensor for detecting the position of axial slide 13 relative to tool carrier 12 along the Z direction. In addition, however, the machine 1 comprises a plurality of further sensors. These sensors include, in particular, further position sensors for detecting an actual position of one linear axis in each case, rotation angle sensors for detecting a rotational position of one rotational axis in each case, current sensors for detecting a drive current of one axis in each case, and further vibration sensors for detecting vibrations of one driven component in each case.

All driven axes of the machine 1 are digitally controlled by a machine controller 40. The machine controller 40 comprises several axis modules 41, a control computer 42 and a control panel 43. The control computer 42 receives operator commands from the control panel 43 as well as sensor signals from various sensors of the machine 1 and calculates control commands for the axis modules 41 from these. It also outputs operating parameters to the control panel 43 for display. The axis modules 41 provide control signals for one machine axis each at their outputs.

A monitoring device 44 is connected to the control computer 42.

The monitoring device 44 may be a separate hardware unit associated with the machine 1. It may be connected to the control computer 42 via an interface known per se, e.g. via the known Profinet standard, or via a network, e.g. via the Internet. It may be spatially part of the machine 1, or it may be spatially remote from the machine 1.

The monitoring device 44 receives a variety of different measurement data from the control computer 42 during operation of the machine. Among the measurement data received from the control computer are sensor data acquired directly by the control computer 42 and data read by the control computer 42 from the axis modules 41, for example, data describing the target positions of the various machine axes and the target current consumption in the axis modules.

The monitoring device 44 may optionally have its own analog and/or digital sensor inputs to directly receive sensor data from further sensors as measurement data. The further sensors are typically sensors that are not directly required for controlling the actual machining process, e.g. acceleration sensors to detect vibrations or temperature sensors.

The monitoring device 44 may alternatively be implemented as a software component of the machine controller 40, for example executing on a processor of the control computer 42, or it may be implemented as a software component of the service server 45 described in more detail below. The service server 45 has a processor 451, which is only indicated schematically, and a storage medium 452.

The monitoring device 44 communicates directly or via the Internet and a web server 47 with the service server 45. The service server 45, in turn, communicates with a database server 46 with database DB. These servers may be located remotely from the machine 1. The servers need not be a single physical entity. In particular, the servers may be implemented as virtual units in the so-called “cloud”.

The service server 45 communicates with a terminal device 48 via the web server 47. The terminal device 48 can, in particular, execute a web browser with which the received data and their evaluation are visualized. The terminal device does not need to meet any particular computing power requirements. For example, the end device may be a desktop computer, a notebook computer, a tablet computer, a cell phone, etc.

### Machining of a Workpiece Lot

The following describes how workpieces are machined with machine 1.

In order to machine a workpiece (blank) that is still unmachined, the workpiece is clamped by an automatic workpiece changer on the workpiece spindle that is in the workpiece change position. The workpiece change takes place in parallel with the machining of another workpiece on the other workpiece spindle, which is in the machining position. When the new workpiece to be machined is clamped and the machining of the other workpiece is completed, the workpiece carrier 20 is swiveled 180° about the C3 axis so that the spindle with the new workpiece to be machined moves to the machining position. Before and/or during the swiveling process, a meshing operation is performed with the aid of the associated meshing probe. For this purpose, the workpiece spindle 21 is set in rotation, and the position of the tooth gaps of the workpiece 23 is measured with the aid of the meshing probe 24. The roll angle is determined on this basis.

When the workpiece spindle carrying the workpiece 23 to be machined has reached the machining position, the workpiece 23 is brought into collision-free engagement with the grinding worm 16 by moving the tool carrier 12 along the X axis. The workpiece 23 is now machined by the grinding worm 16 in rolling engagement. During machining, the workpiece is continuously advanced along the Z axis at a constant radial X infeed. In addition, the tool spindle 15 is moved slowly and continuously along the shift axis Y in order to continuously use unused areas of the grinding worm 16 for machining (so-called shift movement).

Parallel to the workpiece machining, the finished workpiece is removed from the other workpiece spindle and another blank is clamped on this spindle.

If, after machining a certain number of workpieces, the use of the grinding worm 16 has progressed to the point where the grinding worm is too blunt and/or the flank geometry is too inaccurate, then the grinding worm is dressed. For this purpose, the workpiece carrier 20 is swiveled by +90° so that the dressing device 30 reaches a position in which it is opposite the grinding worm 16. The grinding worm 16 is now dressed with the dressing tool 33. The dressing tool here is a rotating dressing wheel.

### Gear Cutting Machine Test Cycle

During machining pauses, a test cycle is performed by the monitoring device 44 in interaction with the machine controller 42 to check the condition of individual or all components of the machine 1. During such a test cycle, a selected part of the machine axes or all machine axes are systematically actuated and measurements are taken on the machine.

For example, each linearly displaceable component is displaced with the associated machine axis, and the instantaneous position of the component is continuously determined with the aid of the aforementioned position sensors. From this, a position deviation between the specification (nominal position) and the measurement (actual position) is continuously determined and transmitted to the monitoring device 44. The same can also be done for the rotationally driven spindles, whereby rotary angle sensors are then used to determine position deviations.

The vibration behavior is also determined for selected machine axes while the machine axis in question is activated. Acceleration sensors (vibration sensors) connected to these components are used for this purpose. The results of the vibration measurements are also transmitted to the monitoring device 44.

Furthermore, the power consumption of the drive motors of the machine axes is continuously determined while they are activated. Current sensors integrated in the axis modules 41, for example, can be used for this purpose. The results of the current measurements are also transmitted to the monitoring device 44.

All this can be done while one machine axis is actuated alone. However, it is also possible to actuate two or more machine axes in a coupled manner, so that the behavior of the machine is recorded when two or more machine axes are actuated simultaneously. In this case, for example, amplified vibrations can occur that are greater than would be expected based solely on the vibration behavior when a single machine axis is actuated, or controller errors can be detected that can only be determined when two machine axes are actuated synchronously.

### Condition Data

The monitoring device 44 determines various condition data from the received measurement data. The condition data allow direct or indirect conclusions to be drawn about the condition of the machine or its individual components. In particular, the condition data comprise spectral data obtained from the measurement data by spectral analyses. Complete spectra or only the spectral intensities at selected discrete excitation frequencies can be determined.

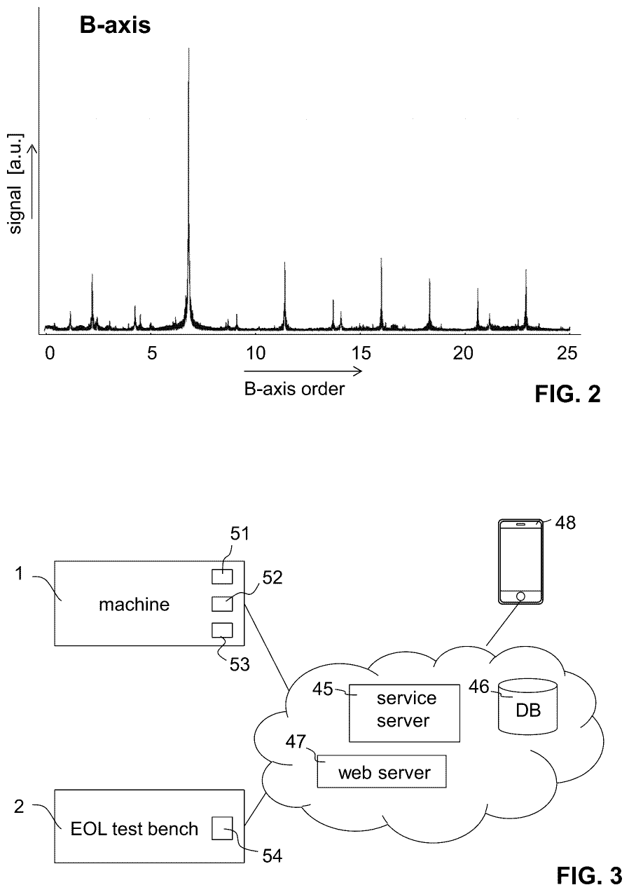

FIG. 2 shows an example of a spectrum that can be obtained from a time signal of an acceleration, position or current sensor recorded during the actuation of a machine axis (here the B axis, i.e. the tool spindle) by filtering and FFT operation. The spectrum of FIG. 2 contains several clearly visible peaks at integer and non-integer multiples of the rotational frequency (orders) of the machine axis in question.

For example, strong peaks at the tool rotational speed and its multiples may indicate concentricity errors in the tool spindle. Peaks at higher multiples of tool rotational speed may indicate bearing damage in the tool spindle, and the bearing orders may be inferred from the multiples. If the bearing orders are known, it may be possible to identify the bearing causing the peaks.

The monitoring device 44 transmits the condition data thus obtained to the service server 45.

### EOL Test

The finished machined workpieces are each installed in a gear train. The gear train is tested on an EOL test bench before delivery. This is explained in more detail with reference to FIG. 3.

FIG. 3 shows in a highly schematic manner the machine 1 with the various servers 45-47 and the terminal device 48, which have already been described above. Also shown is a highly schematic EOL test bench 2. The EOL test bench communicates with the service server 45 via the web server 47.

As explained earlier, the machine 1 has a plurality of sensors, including acceleration sensors (vibration sensors) 51, position sensors 52, and current sensors 53. As also explained earlier, the machine uses these sensors to collect measurement data and sends condition data derived therefrom to the service server 45.

The EOL test bench also has a variety of sensors, including accelerometers 54 that measure acoustic signals as the installed workpiece in the gear train rolls off on a mating gear, rotation angle sensors, and so on. The EOL test bench calculates EOL data from these by spectral analysis and also sends them to the service server 45.

### Service Server

The service server 45 processes the received data, calculates further quantities from it if necessary, and stores the received data and the calculated further quantities in the database DB if necessary. In particular, the service server stores the following data:
Condition data with associated condition identification data, which allow unique identification of the machine on which the condition data were determined and the associated operation in the test cycle (in particular the actuated machine axis), as well as time of the test cycle;
Process data of the machining process for each workpiece, together with workpiece identification data that allows unique identification of the workpiece;
EOL data from the EOL test bench, together with the associated workpiece identification data.

The service server can read and merge data from the database. In particular, the service server can merge EOL data for a specific workpiece with the associated process data and those machine condition data that best characterize the machine condition to the processing condition, each to form a data set.

### Prediction of Perturbing Noise Excitations in the EOL Spectrum Based on Kinematic Linkages

The service server can make a qualitative prediction of the intensities of perturbation orders on the EOL test bench. For this purpose, the service server calculates a corresponding expected excitation spectrum on the EOL test bench (EOL spectrum) from the spectrum of FIG. 2.

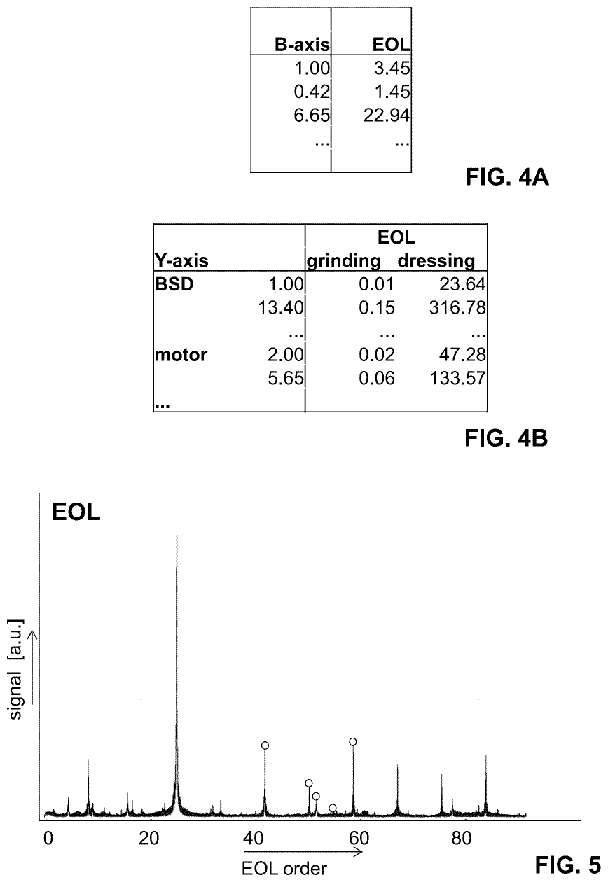

In the calculation, the service server exploits the known kinematic linkages between the components of the machine 1. This is explained in more detail with reference to FIGS. 4A and 4B.

FIG. 4A shows an example of a section of a table in which known possible perturbation orders of the B axis (i.e. the tool spindle) and the corresponding expected perturbation orders in the EOL spectrum are entered. In the present example, these perturbation orders are in a fixed ratio 3.45, which is given by the kinematic linkage between the tool spindle and the workpiece, i.e. by the rolling coupling between the tool and the workpiece, and is determined by the geometry of the workpiece and the grinding worm. Figuratively speaking, the ratio indicates how a vibration of the B axis is propagated into a waviness on the tooth flanks of the workpiece. This ratio can be calculated by taking into account the contact conditions between the grinding worm and the workpiece. It is referred to below as the “propagation factor”. The possible perturbation orders of the B axis can be calculated in advance if the orders of the components of the B axis, e.g. bearing orders and motor orders, are known. Real perturbation orders of the B axis can be determined by measurements.

FIG. 4B shows an example of a section of a table in which possible perturbation orders of the Y-axis (i.e. the shift axis) and the corresponding expected perturbation orders in the EOL spectrum are entered. The table distinguishes on the one hand between different components of the Y-axis, e.g. ball screw drive BSD and drive motor, which can cause these perturbation orders, and on the other hand between perturbation orders in the EOL spectrum due to vibrations during workpiece machining (grinding) and dressing. Vibrations during grinding lead directly to flank ripples (waviness) on the workpiece flanks. Vibrations during dressing initially lead to flank ripples on the grinding worm and are also translated from there into flank ripples on the workpiece flanks during grinding. The corresponding propagation factors between possible perturbation orders of the Y-axis and resulting perturbation orders in the EOL spectrum can also be easily calculated if the kinematic linkages and the machining parameters during grinding and dressing are known. The possible perturbation orders of the Y-axis can again either be measured or calculated.

This type of analysis of possible perturbation orders of a machine axis and the resulting perturbation orders in the EOL spectrum can be performed for each machine axis involved in the grinding process.

The prediction of an EOL spectrum is now made on the basis of the spectra determined in the test cycle on the machine and the known propagation factors between perturbation orders of the machine axes and associated perturbation orders in the EOL spectrum. This is explained in more detail with reference to FIG. 5. FIG. 5 shows a predicted EOL spectrum expected when the B-axis test in the test cycle resulted in the spectrum of FIG. 2. The predicted EOL spectrum is essentially the same as the spectrum of FIG. 2, but is stretched along the horizontal axis by the propagation factor 3.45 already mentioned above as an example. However, the absolute signal values in this EOL spectrum should be viewed with caution: After all, how strong an EOL signal will actually be for a given perturbation order depends not only on the strength of the corresponding perturbation order of the causative machine axis, but also on a large number of other factors during workpiece machining and the installation conditions of the workpiece in the gear train. In this respect, the spectrum of FIG. 5 does not allow any quantitative statements about expected signal strengths. It does, however, allow a prediction of which perturbation orders will actually be present in the EOL spectrum due to the perturbation orders present in the spectrum of the machine axis in question, and it allows a qualitative estimate of the expected signal strengths at these perturbation orders. For example, the spectrum of FIG. 5 allows a rough estimate of the signal strengths at certain perturbation orders of interest that cause noise perceived as particularly unpleasant. Such perturbation orders are marked with a circle in FIG. 5 as an example.

Overall, a good prediction can thus be made as to which perturbation orders with approximately which signal strengths are to be expected due to which causes in the EOL spectrum.

For example, a worn bearing of the tool spindle can cause vibrations of the tool spindle, whereby the orders of these vibrations (related to the tool rotation) are determined by the bearing orders. The bearing orders result from the design of the bearing and can often be obtained from the bearing manufacturer. Therefore, vibrations measured in a test cycle may be directly attributed to the worn bearing. These vibrations can be measured, for example, by an acceleration sensor on the housing of the workpiece spindle. The vibrations are propagated to the workpieces by the machining process and manifest themselves there as periodic deviations (ripples/waviness) on the tooth flank. After installation in a gear train, these ripples manifest themselves as noise excitations when the workpiece toothing rolls off on a mating gear. The order of these noise excitations in relation to the rotation of the workpiece in the gear train can be easily calculated on the basis of the above considerations. In this way, it is possible to calculate how the worn bearing will affect the noise spectrum of a gear train.

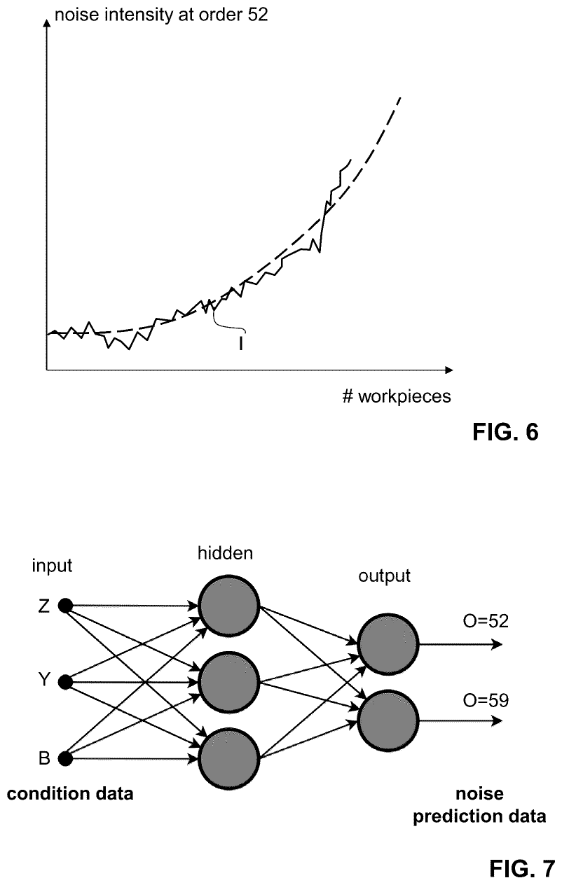

The calculated spectrum of FIG. 5 alone does not allow any quantitative statements about expected signal strengths. However, by observing how this expected spectrum changes from test cycle to test cycle, a very good estimate can be made of which perturbation orders change and in what way. This is exemplified below with reference to FIG. 6. FIG. 6 shows a diagram in which the expected spectral intensity I in the EOL test bench at a certain order (here order 52) is plotted as a function of the number of workpieces processed with the machine. It can be seen that the expected noise intensity strongly increases with time. By fitting to a suitable regression function (here a quadratic regression function), this increase can be quantified, and depending on the determined regression parameters, a suitable action can be triggered, e.g. a warning signal can be issued. The time evolution of the expected signal strengths at the different EOL orders can also be visualized in a suitable way. This enables even inexperienced users to interpret noise problems.

### Identification of Sources of Perturbation Based on Kinematic Linkages

The reverse is also possible: If an EOL spectrum has been determined by measurements on the EOL test bench, the above considerations can be used to estimate which machine axes and, if necessary, which components of a machine axis have caused the perturbation orders in the measured EOL spectrum. For this purpose, it is calculated back which orders of machine axes correspond to the perturbation orders in the measured EOL spectrum, and the component is searched for whose expected perturbation orders in the spectrum of a machine axis correspond to the orders calculated back in this way. This process can be easily automated.

Procedure without Knowledge of the Kinematic Linkages

If the kinematic linkages of the drive train are not known or for other reasons should not be used for a calculation, it is possible to perform a prediction of signal intensities at certain EOL perturbation orders or an identification of perturbation sources using a machine learning (ML) algorithm.

This is explained below with reference to FIG. 7. This is a highly simplified schematic sketch of an artificial neural network (ANN). In this example, this network has only three inputs and two outputs and only one hidden layer. In reality, an ANN will usually have more inputs, outputs and hidden layers.

In the present example, condition data are fed to the ANN at the inputs, each characterizing the vibration propensity of one of the axes B, Y and Z of the machine. The ANN calculates predicted EOL spectral data from this in the form of expected spectral intensities at two specific EOL orders, here orders 52 and 59.

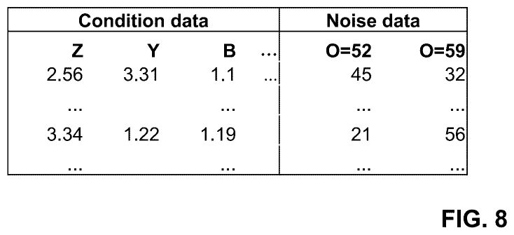

The ANN was previously trained with training data. FIG. 8 shows an example of a section of such training data. FIG. 8 shows a table in which, on the one hand, condition data are entered that were determined from many test cycles of the machine. On the other hand, EOL data in the form of spectral intensities at orders 52 and 59 are entered, which were obtained by EOL measurements on gear trains. In these gear trains, workpieces were installed that were machined with the machine when it was in the condition in which the condition data were obtained (i.e., just before and/or after the respective test cycle). The table contains very many rows of this type. It can be obtained from the database DB of FIGS. 1 and 3. The ANN has been trained with this data in a manner known per se. Thus, it is able to reliably predict which conditions of the machine (represented by condition data) will lead to which EOL intensities at the mentioned orders.

The reverse is also possible: the input variables of a corresponding ANN can be EOL data, and the output data can be predicted condition data.

Of course, the above example is highly simplified, but it demonstrates the basic approach. Instead of an ANN, other types of ML algorithms can be used, especially other well-known classifiers.

### Output of Results and Visualization

The visualization of the results of these analyses can be carried out platform-independently on any client computer via a web browser. Other evaluation measures can also be implemented in a correspondingly platform-independent manner. This facilitates analysis even remotely. In particular, the status of any machine can be checked in detail from any mobile device via the cloud.

In addition, it is conceivable to send a corresponding message automatically via SMS, push message or e-mail if conditions exist that require intervention.

1. A method of monitoring a condition of a gear cutting machine having a plurality of machine axes, comprising the steps of:
a) performing a test cycle, wherein in the test cycle at least a portion of the machine axes is systematically actuated and associated machine measurement data are obtained;
b) performing a spectral analysis of the machine measurement data, wherein machine spectral data are calculated from the machine measurement data; and
c) determining predicted EOL spectral data based on the machine spectral data, wherein the predicted EOL spectral data indicate at which orders excitations are to be expected in an EOL spectrum when a workpiece machined with the gear cutting machine is installed in a gear train and rolls off on a mating gear in the gear train.

2. The method according to claim 1, comprising:
d) outputting the predicted EOL spectral data or at least one quantity derived therefrom.

3. The method according to claim 1, wherein determining the predicted EOL spectral data comprises applying a propagation factor to the machine spectral data, the propagation factor depending on a kinematic linkage between the machine axis for which the machine spectral data was determined and the workpiece.

4. The method according to claim 1, wherein the predicted EOL spectral data are determined individually per actuated machine axis.

5. The method according to claim 1,
where steps a) to c) are repeated several times,
wherein workpieces are machined with the gear cutting machine between the test cycles and the test cycles are performed in machining pauses in which the machining tool is not in a machining engagement with a workpiece, and
wherein a development of the predicted EOL spectral data as a function of the test cycles performed, the workpieces machined or the time is visualized and/or analyzed.

6. The method according to claim 1,
wherein reference machine spectral data are available for a plurality of reference machines, the reference machine spectral data having been determined by a plurality of reference test cycles performed on the reference machines,
where predicted reference EOL spectral data are determined from the reference machine spectral data,
wherein the predicted EOL spectral data, which have been determined based on the machine spectral data of the monitored gear cutting machine, are compared to the predicted reference EOL spectral data or quantities derived therefrom.

7. A method of monitoring a condition of a gear cutting machine having a plurality of machine axes, comprising the steps of:
a) performing an EOL test on a gear train comprising a workpiece machined by the gear cutting machine, wherein in the EOL test the workpiece in the gear train rolls off on a mating gear and associated EOL measurement data are determined;
b) performing a spectral analysis of the EOL measurement data, wherein EOL spectral data from the EOL measurement data are calculated; and
c) determining predicted condition data based on the EOL spectral data, wherein the predicted condition data for at least one machine axis indicates which orders of that machine axis are consistent with the calculated EOL spectral data.

8. The method according to claim 7, comprising:
d) outputting the predicted condition data or at least one quantity derived therefrom.

9. The method according to claim 7, comprising:
e) performing a test cycle in which at least a portion of the machine axes are systematically actuated and associated machine measurement data are obtained;
f) performing a spectral analysis of the machine measurement data, wherein machine spectral data are calculated from the machine measurement data; and
g) determining predicted EOL spectral data based on the machine spectral data, wherein the predicted EOL spectral data indicate at which orders excitations are to be expected in an EOL spectrum when a workpiece machined by the gear cutting machine is installed in a gear train and rolls off on a mating gear in the gear train,
wherein determining the predicted condition data comprises comparing the EOL spectral data calculated from the EOL measurement data to the predicted EOL spectral data.

10. A method for creating a training data set of a machine learning algorithm for monitoring a condition of a gear cutting machine with a plurality of machine axes, comprising:
a) performing a test cycle in which at least a portion of the machine axes is systematically actuated and associated condition data are determined by measurements;
b) machining at least one workpiece with the gear cutting machine while the gear cutting machine is in a condition that corresponds to the condition data;
c) installing the machined workpiece in a gear train;
d) performing an EOL test on the gear train, wherein in the EOL test the workpiece in the gear train rolls off on a mating gear and associated EOL data are determined;
e) storing the condition data and the corresponding EOL data in the training data set;
f) repeating steps a) to e) for a plurality of test cycles and machined workpieces, wherein the workpieces have the same nominal geometry and are machined under the same machining conditions.

11. A method of training a machine learning algorithm, wherein the machine learning algorithm is trained using the training data set according to claim 10.

12. A method of monitoring a condition of a gear cutting machine with a plurality of machine axes, comprising using
a machine learning algorithm trained with the training data set according to claim 10.

13. The method according to claim 12,
wherein the machine learning algorithm has condition data of the gear cutting machine as input variables and predicted EOL data as output variables,
the method comprising:
a) performing a test cycle, wherein in the test cycle at least a portion of the machine axes is systematically actuated and associated condition data are determined by measurements; and
b) determining predicted EOL data based on the condition data by feeding the condition data to the trained ML algorithm as input variables.

14. The method according to claim 12,
wherein the machine learning algorithm has EOL data as input variables and predicted condition data of the gear cutting machine as output variables,
the method comprising:
a) performing an EOL test on the gear train, wherein in the EOL test the workpiece in the gear train rolls off on a mating gear and associated EOL data are determined; and
b) determining predicted condition data based on the EOL data by feeding the EOL data to the trained ML algorithm as input variables.

15. The method according to claim 10, wherein
the machine learning algorithm is a classification algorithm, in particular an artificial neural network or a support vector machine, or a random forest.

16. The method according to claim 10,
wherein the condition data correlate with a condition of a machine axis with respect to its vibration behavior,
and/or
wherein the EOL data correlate with the noise behavior of the gear train.

17. A device for monitoring a condition of a gear cutting machine having a plurality of machine axes, comprising a processor (451) and a storage medium (452) on which is stored a computer program which, when executed on the processor, causes the following steps to be performed:
receiving condition data determined by a test cycle of the gear cutting machine, wherein in the test cycle at least a portion of the machine axes has been systematically actuated and the associated condition data have been determined by measurements; and
determining predicted EOL data correlated with a noise behavior of a gear train comprising a workpiece machined with the gear cutting machine, based on the condition data.

18. A device for monitoring a condition of a gear cutting machine having a plurality of machine axes, comprising a processor (451) and a storage medium (452) on which is stored a computer program which, when executed on the processor, causes the following steps to be performed:
receiving EOL data determined by an EOL test on a gear train comprising a workpiece machined by the gear cutting machine, wherein in the EOL test the workpiece in the gear train rolls off on a mating gear and the associated EOL data was determined; and
determining predicted condition data that correlates with a condition of at least one machine axis in terms of its vibration behavior, based on the EOL data.

19. The method according to claim 5, wherein the development of the predicted EOL spectral data is analyzed by a regression analysis.

20. The method according to claim 6, wherein the method comprises a statistical analysis of the predicted reference EOL spectral data.

21. The method according to claim 10, wherein the condition data comprise machine spectral data calculated by a spectral analysis of machine measurement data.

22. The method according to claim 10, wherein the EOL data comprise EOL spectral data calculated by spectral analysis of EOL measurement data.

23. The method according to claim 13, comprising:
c) outputting the predicted EOL spectral data or at least one quantity derived therefrom.

24. The method according to claim 14, comprising:
c) outputting the predicted condition data or at least one quantity derived therefrom.
